(19) United States
(12) Patent Application Publication
(10) Pub. No.: US 2022/0138421 A1
(43) Pub. Date: May 5, 2022

(54) INFORMATION PROCESSING SYSTEM AND NON-TRANSITORY COMPUTER READABLE MEDIUM STORING PROGRAM

(71) Applicant: FUJIFILM Business Innovation Corp., Tokyo (JP)

(72) Inventor: Yasuhiko IWASAKI, Kanagawa (JP)

(73) Assignee: FUJIFILM Business Innovation Corp., Tokyo (JP)

(21) Appl. No.: 17/313,011

(22) Filed: May 6, 2021

(30) Foreign Application Priority Data
Nov. 4, 2020 (JP) 2020-184114

(51) Int. Cl. G06F 40/279; G06F 40/166; G06K 9/00

(52) U.S. Cl. CPC G06F 40/279; G06K 9/00463; G06F 40/166

(57) ABSTRACT

An information processing system includes a processor configured to: extract first characteristic values indicating frequencies of appearance of words in a target document to be processed among plural documents managed based on a hierarchical relationship; extract second characteristic values of the words that are correlated to reciprocals of ratios of the number of documents including the words to a total number of documents in a group of documents in a first group including the target document; and assign words selected from among the words based on the first characteristic values and the second characteristic values to the target document as first attributes.

### CROSS-REFERENCE TO RELATED APPLICATIONS

This application is based on and claims priority under 35 USC 119 from Japanese Patent Application No. 2020-184114 filed Nov. 4, 2020.

### BACKGROUND

### (i) Technical Field

The present disclosure relates to an information processing system and a non-transitory computer readable medium storing a program.

### (ii) Related Art

Document files (hereinafter referred to as “documents”) to be handled in computers or servers are saved at positions managed based on, for example, a hierarchical relationship. For example, this relationship is called “directory structure”. Documents have attributes for their management. For example, Japanese Unexamined Patent Application Publication No. 2003-316629 describes a technology for assigning information prepared in advance for a directory (hereinafter referred to also as “folder”) as an attribute of a newly registered document.

### SUMMARY

Aspects of non-limiting embodiments of the present disclosure relate to the following circumstances. The method for assigning information prepared in advance for a registration-destination directory as an attribute of a newly registered document allows a user to set the information only once, but the user's work is still needed.

Words in a document to be registered may be analyzed and assigned as attributes of the document. However, frequently appearing words do not always show the contents of the document.

It is appropriate that attributes to be assigned to a document show the contents of the document more accurately than in a case where words in a document are analyzed and attributes are assigned to the document.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system comprising a processor configured to: extract first characteristic values indicating frequencies of appearance of words in a target document to be processed among a plurality of documents managed based on a hierarchical relationship; extract second characteristic values of the words that are correlated to reciprocals of ratios of the number of documents including the words to a total number of documents in a group of documents in a first group including the target document; and assign words selected from among the words based on the first characteristic values and the second characteristic values to the target document as first attributes.

### BRIEF DESCRIPTION OF THE DRAWINGS

Exemplary embodiments of the present disclosure will be described in detail based on the following figures, wherein:

FIG. 1 schematically illustrates an example of the overall configuration of a network system according to a first exemplary embodiment;

FIG. 2 illustrates an example of the hardware configuration of a document management system according to the first exemplary embodiment;

FIG. 3 illustrates a part of functions implemented by a processor according to the first exemplary embodiment;

FIG. 4 illustrates an example of a data structure for management of a target document by the document management system;

FIG. 5 is a flowchart illustrating an example of processing operations of the document management system according to the first exemplary embodiment;

FIG. 6 is a table illustrating an example of word lists to be generated for individual operations;

FIG. 7 is a flowchart illustrating an example of processing operations to be executed in Step 5;

FIG. 8 is a flowchart illustrating an example of processing operations to be executed in Step 6, Step 55, and Step 58;

FIG. 9 is a flowchart illustrating an example of processing operations to be executed in Step 65;

FIG. 10 is a flowchart illustrating an example of processing operations to be executed in Step 56;

FIG. 11 conceptually demonstrates a processing operation corresponding to Step 1;

FIG. 12 conceptually demonstrates processing operations corresponding to Step 2 to Step 5 according to the first exemplary embodiment;

FIG. 13 illustrates an example of extracted words;

FIG. 14 illustrates an example of the structure of a word list generated for a document;

FIG. 15 illustrates an example of the structure of a word list generated for a parent folder;

FIG. 16 conceptually demonstrates processing operations corresponding to Step 57 to Step 59 according to the first exemplary embodiment;

FIG. 17 conceptually demonstrates processing operations corresponding to Step 54 to Step 57 according to the first exemplary embodiment;

FIG. 18 illustrates a range that affects attributes of the target document according to the first exemplary embodiment;

FIG. 19 conceptually demonstrates other processing operations corresponding to Step 2 to Step 5 according to the first exemplary embodiment;

FIG. 20 conceptually demonstrates other processing operations corresponding to Step 57 to Step 59 according to the first exemplary embodiment;

FIG. 21 conceptually demonstrates other processing operations corresponding to Step 54 to Step 57 according to the first exemplary embodiment;

FIG. 22 illustrates a range that affects attributes of a target document according to a second exemplary embodiment;

FIG. 23 illustrates an example of the hardware configuration of a document management system according to a third exemplary embodiment;

FIG. 24 illustrates a part of functions implemented by a processor according to the third exemplary embodiment;

FIG. 25 illustrates virtual attributes assigned to a target document;

FIG. 26 illustrates an example of a screen to be presented to a user when moving or copying the target document to a different folder;

FIG. 27 is a flowchart illustrating an example of processing operations of a virtual attribute manager according to the third exemplary embodiment;

FIG. 28 is a flowchart illustrating an example of processing operations to be executed in Step 6A and Step 7;

FIG. 29 is a flowchart illustrating an example of processing operations for transferring virtual attributes of a parent folder;

FIG. 30 illustrates how virtual attributes are assigned; and

FIGS. 31A and 31B illustrate changes of virtual attributes when a target document having the virtual attributes is moved to a different folder, in which FIG. 31A illustrates an example of the virtual attributes before the movement and FIG. 31B illustrates an example of the virtual attributes after the movement.

### DETAILED DESCRIPTION

Exemplary embodiments of the present disclosure are described below with reference to the drawings.

### First Exemplary Embodiment

### <System Configuration>

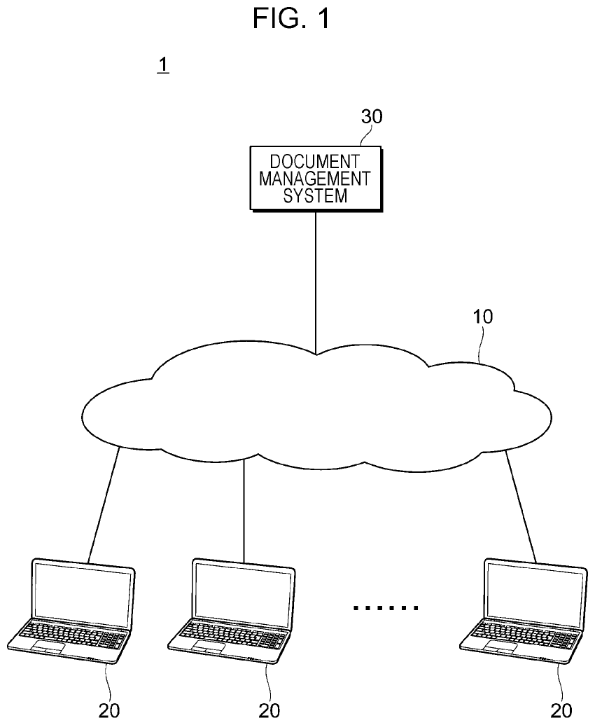

FIG. 1 schematically illustrates an example of the overall configuration of a network system 1 according to a first exemplary embodiment.

The network system 1 illustrated in FIG. 1 includes a network 10, user terminals 20 to be operated by users of the system, and a document management system 30 that manages documents. The document management system 30 is an example of an information processing system.

Examples of the documents of this exemplary embodiment include office documents created by using office software or other application programs, electronic mails, image data obtained by optically reading originals, facsimile documents, photographs, accounting data, medical data, and databases. Image documents include not only still images but also videos. The still images include diagrams and pictures.

The document of this exemplary embodiment may be accessible only to a user who registered the document, or may be shared in an organization or among a plurality of users determined in advance.

Examples of the network 10 include a local area network (LAN) and the Internet. The network 10 may be a combination of the LAN and the Internet.

Examples of the user terminal 20 include a notebook computer, a desktop computer, a tablet computer, a smartphone, and an image forming apparatus, which are used for uploading documents to or downloading documents from the document management system 30. The user terminal 20 is also used for instructions to modify or delete documents stored in the document management system 30 or move, copy, or search folders serving as storage destinations.

Any user terminal 20 includes a motherboard having an integrated circuit that processes data, a storage that stores data, a display that displays information, a touch panel or a keyboard for operations, and a communication module for communication with the network 10.

For example, the motherboard includes a processor, a random access memory (RAM) serving as a program execution area, and a read only memory (ROM) that stores a basic input/output system (BIOS).

The image forming apparatus of this exemplary embodiment has functions of printing images on paper, optically reading images from originals or the like, and executing facsimile communication. This type of image forming apparatus is also called “multifunction peripheral”. Those functions of the image forming apparatus are some examples and other functions may be provided.

The storage is a hard disk drive or a rewritable non-volatile semiconductor memory.

FIG. 1 illustrates the plurality of user terminals 20 but the user terminal 20 may be provided alone.

The document management system 30 provides a document management service as a cloud service. The network system 1 illustrated in FIG. 1 has one document management system 30 but may have a plurality of document management systems 30.

The document management system 30 is physically constructed of one or more servers. The servers may be so-called cloud servers. The servers may be on-premises servers.

### <Configuration of Document Management System>

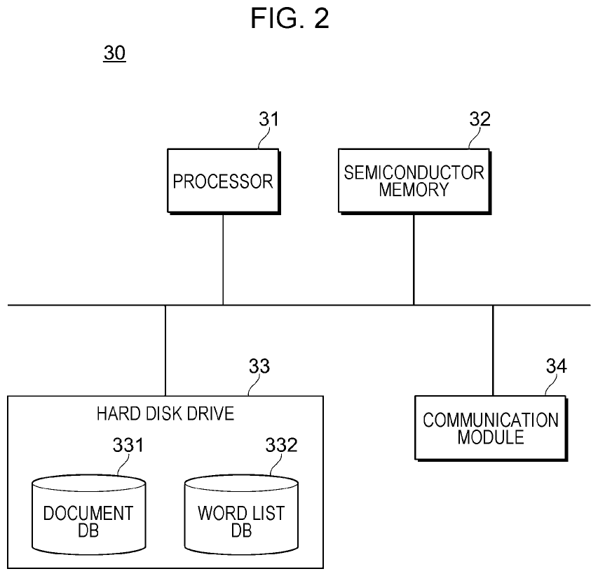

FIG. 2 illustrates an example of the hardware configuration of the document management system 30 according to the first exemplary embodiment.

The document management system 30 illustrated in FIG. 2 is basically constructed of a server including a processor 31 that controls overall operations of the system, a semiconductor memory 32, a hard disk drive 33, and a communication module 34. Those components are connected via a signal line or a bus.

The processor 31 implements various functions by executing programs. The processor 31 of this exemplary embodiment provides the document management service.

For example, the semiconductor memory 32 includes a ROM and a RAM. The RAM is an example of a main memory.

The processor 31 and the semiconductor memory 32 constitute a so-called computer.

Examples of the communication module 34 include an Ethernet (registered trademark) module, a wireless LAN module, and a module for a fifth-generation mobile communication system (i.e., 5G).

The hard disk drive 33 is an example of an auxiliary memory and stores, for example, an operating system and application programs. A large-capacity semiconductor memory may be used in place of the hard disk drive 33.

The hard disk drive 33 of this exemplary embodiment stores a document database (hereinafter referred to as “document DB”) 331 that stores documents to be managed, and a word list database (hereinafter referred to as “word list DB”) 332 that stores lists of words (hereinafter referred to as “word lists”) for management of documents and folders.

The word list DB 332 stores a word list generated on a document basis, and a word list generated on a folder basis.

The word list is used for assigning attributes to a document or folder. In this exemplary embodiment, the assigned attributes are characteristic words showing the contents of the document or folder.

In this exemplary embodiment, the attributes are used, for example, for searching for the document or folder.

The word list of a document is generated when attributes are needed for the document, and is stored in the word list DB 332. Examples of the case where attributes are needed for the document include a case where the document is newly registered in the hard disk drive 33, a case where the contents of the document are modified, and a case where the document is deleted from the hard disk drive 33.

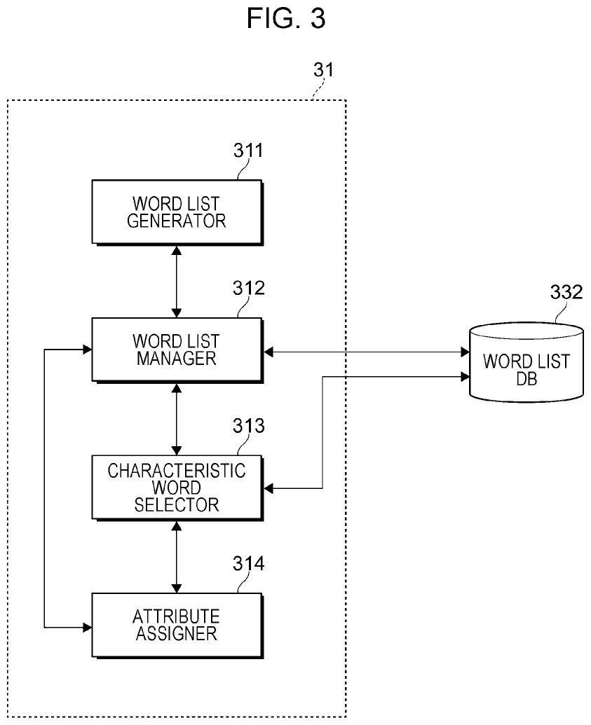

FIG. 3 illustrates a part of functions implemented by the processor 31 according to the first exemplary embodiment. FIG. 3 illustrates a word list generator 311 that generates word lists (see FIG. 2), a word list manager 312 that manages word lists, a characteristic word selector 313 that selects characteristic words from word lists, and an attribute assigner 314 that assigns attributes to documents (see FIG. 2). Those functions are implemented by executing programs by the processor 31.

The word list generator 311 extracts words from documents, and generates word lists of the documents and word lists of folders.

The word list generator 311 individually measures counts of extracted words appearing in a document (hereinafter referred to as “appearance counts”), and generates a word list of the document.

The word list generator 311 generates word lists of folders at individual hierarchical levels. The word list of each folder includes all words extracted from all documents stored in the folder. The word list generator 311 generates the word list of the folder by using word lists of the documents in the folder. Appearance counts of the words are measured also in the word list of the folder.

The word list generator 311 calculates the “total sum of appearing words”, which is the sum of the appearance counts. The total sum of appearing words is calculated for the word list of each document and for the word list of each folder.

The word list manager 312 manages updates of stored word lists. The word list manager 312 updates word lists of all folders related to a document depending on a type of operation on the document. Examples of the type of operation include registration, modification, deletion, movement, and copying. All the folders related to a document are a folder including the document and its higher-level folders.

The word list manager 312 calculates a list of words that increase or decrease in number depending on the type of operation (hereinafter referred to as “word increase/decrease list”), and reflects the word increase/decrease list in the word lists of the related folder.

The word list manager 312 has a function of excluding in advance words having low possibilities of being assigned as attributes from words in a word list. In this exemplary embodiment, the words to be excluded are also referred to as “general words”. The general word is a word having a large appearance count but a low possibility of showing a characteristic content of a document or folder.

The characteristic word selector 313 selects characteristic words that characterize a target document and characteristic words that characterize a target folder based on word lists stored in the hard disk drive 33 (see FIG. 2).

In this exemplary embodiment, words having higher evaluation values among words extracted from the word lists are selected as the characteristic words of the document and the characteristic words of the folder. In this exemplary embodiment, a TF-IDF value is used as the evaluation value. The TF-IDF value is a product of a TF value and an IDF value. The evaluation value may be calculated as a product of a weighted TF value and a weighted IDF value or calculated by using other formulae.

In this exemplary embodiment, the characteristic word of the document is selected based on a first characteristic value and a second characteristic value of each word in the document. The TF value of each word in the document is an example of the first characteristic value. The TF value of each word in the document indicates a frequency of appearance of the word in the document. Specifically, the TF value may be calculated as a ratio of an appearance count of the word to the sum of appearance counts of all the words in the document. The TF value increases as the frequency of appearance of the word increases.

The IDF value of each word in the document is an example of the second characteristic value. The IDF value of each word in the document is a logarithm of a value obtained by dividing the total number of documents in a folder including the document by the number of documents including the word. The IDF value increases as the number of documents including the word decreases.

The characteristic word selector 313 selects words (e.g., n words) having high TF-IDF values as the characteristic words of the document.

The TF-IDF values need not be calculated for all the words in the document but may be calculated for a necessary number of words to select the n characteristic words of the document.

In this exemplary embodiment, the characteristic word of the folder is selected based on a third characteristic value and a fourth characteristic value of each word appearing in a group of documents in the folder (hereinafter referred to as “each word in folder”). The TF value of each word in the folder is an example of the third characteristic value. The TF value of each word in the folder is a value correlated to a frequency of appearance of the word in the group of documents in the folder. Specifically, the TF value may be calculated as a ratio of an appearance count of the word to the sum of appearance counts of all the words in the group of documents in the folder. Similarly to the TF value of the document, the TF value increases as the frequency of appearance of the word increases.

The IDF value of each word in the folder is an example of the fourth characteristic value. The IDF value of each word in the folder is a logarithm of a value obtained by dividing the total number of documents in a higher-level folder incorporating the folder by the total number of documents including the word. The IDF value increases as the number of documents including the word decreases.

The characteristic word selector 313 selects words having high TF-IDF values as the characteristic words of the folder.

The TF-IDF values need not be calculated for all the words in the folder but may be calculated for a necessary number of words to select the n characteristic words of the folder.

The attribute assigner 314 assigns the selected characteristic words as attributes to the target document, the folder including the target document, and the higher-level folder incorporating the folder.

In response to registration, modification, deletion, movement, or copying of the target document, the attribute assigner 314 causes the word list manager 312 to update the word lists associated with the target document, the folder including the target document, and the higher-level folder incorporating the folder.

### <Description of Terms>

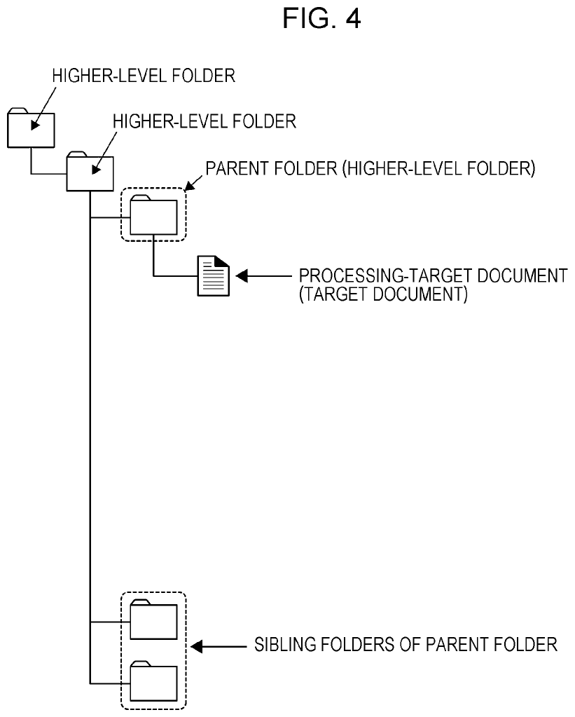

FIG. 4 illustrates an example of a data structure for management of the target document by the document management system 30 (see FIG. 1).

The document management system 30 of this exemplary embodiment manages the target document in a directory structure. That is, the document management system 30 manages the target document based on a hierarchical relationship.

In this exemplary embodiment, assuming a document as a processing target, a “parent folder” of the target document is a folder at the lowermost level among folders incorporating the target document (i.e., a folder at a level immediately above the target document). Assuming a folder as a processing target, a “parent folder” of the target folder is a folder at the lowermost level among folders incorporating the target folder (i.e., a folder at a level immediately above the target folder).

In this exemplary embodiment, assuming a document as a processing target, “higher-level folders” of the target document are a parent folder, a folder incorporating the parent folder, and a folder incorporating the folder. In FIG. 4, three higher-level folders are present in relation to the target document.

A “sibling folder” is a folder positioned at the same level as that of the parent folder and included in the same folder as that of the parent folder.

The parent folder is an example of a first group.

As described above, the word list of this exemplary embodiment is generated for each folder in one hierarchical level.

Higher and lower hierarchical levels are represented by “parent” and “child” as described above. A folder incorporating the parent folder including the target document is a folder that is one level higher than the parent folder. A folder at the highest level in FIG. 4 is a folder that is two levels higher than the parent folder.

The folder at the highest level is generally a root folder.

In FIG. 4, the root folder at the highest level in the directory structure is a first level, a level below the first level is a second level, and a level below the second level is a third level. In FIG. 4, the parent folder and its sibling folders are present at the third level.

In this exemplary embodiment, the root folder is also a folder positioned at the highest level in a reference range for assignment of attributes to the target document.

### <Processing Operations>

### <Overall Processing Operations>

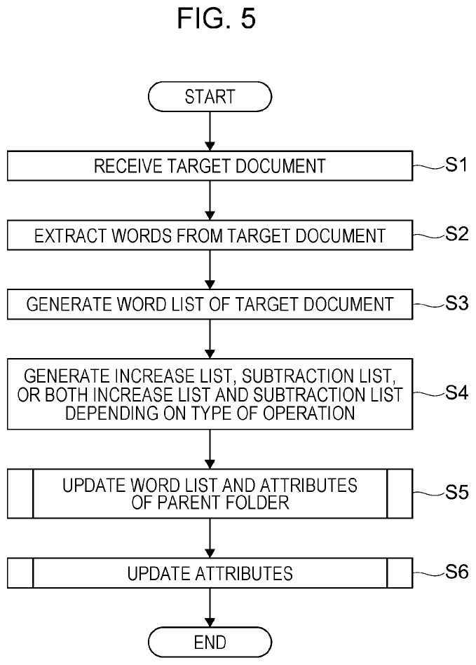

FIG. 5 is a flowchart illustrating an example of processing operations of the document management system 30 according to the first exemplary embodiment. In FIG. 5, the symbol “S” represents “step”.

First, the processor 31 receives a target document from the user terminal 20 (see FIG. 1) (Step 1). Examples of the reception of the target document include registration, modification, deletion, movement, and copying. The target document is linked to any folder.

Next, the processor 31 extracts words from the target document (Step 2), and then generates a word list (see FIG. 2) of the target document (Step 3).

Then, the processor 31 generates an increase list, a subtraction list, or both the increase list and the subtraction list depending on the type of operation (Step 4).

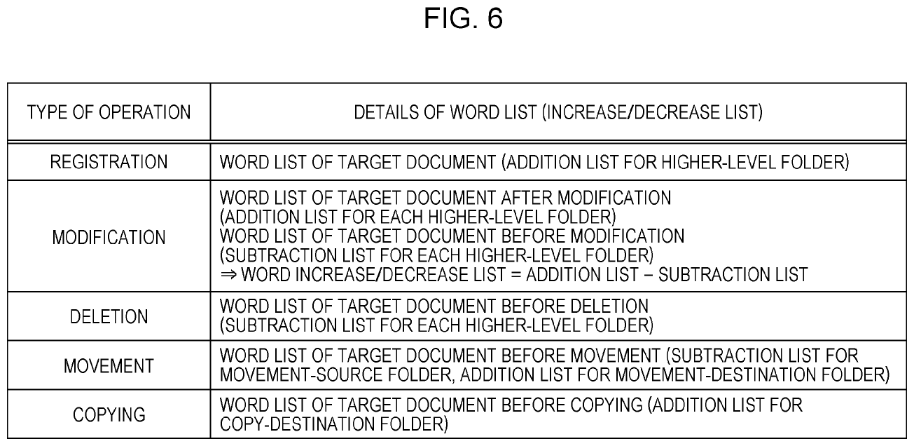

FIG. 6 is a table illustrating an example of word lists to be generated for individual operations.

If the type of operation is registration, the processor 31 generates a word list of the target document. When a new document is registered, the generated word list is also used as an addition list for a higher-level folder of the target document.

If the type of operation is modification, the processor 31 generates a word list of the target document after the modification. This word list is used as an addition list for the higher-level folder.

The processor 31 also newly generates a word list of the target document before the modification as a subtraction list for the higher-level folder. If the word list of the target document is still stored in the hard disk drive 33 after attributes are assigned to the target document, the processor 31 acquires the word list of the target document before the modification from the hard disk drive 33 and uses the word list as the subtraction list for the higher-level folder.

A word list obtained by removing the subtraction list from the addition list is hereinafter referred to as “word addition/subtraction list”.

If the type of operation is deletion, the processor 31 generates a word list of the target document before the deletion. This word list is used as a subtraction list for the higher-level folder.

If the word list of the target document is still stored in the hard disk drive 33 after attributes are assigned to the target document, the processor 31 acquires the word list of the target document before the deletion from the hard disk drive 33 and uses the word list as the subtraction list for the higher-level folder.

If the type of operation is movement, the processor 31 generates a word list of the target document. This word list is used as a subtraction list for a movement-source folder and an addition list for a movement-destination folder.

If the word list of the target document is still stored in the hard disk drive 33 after attributes are assigned to the target document, the processor 31 acquires the word list of the target document from the hard disk drive 33 and uses the word list as the subtraction list for the higher-level folder.

If the type of operation is copying, the processor 31 generates a word list of the target document. This word list is used as an addition list for a copy-destination folder.

If the word list of the target document is still stored in the hard disk drive 33 after attributes are assigned to the target document, the processor 31 acquires the word list of the target document from the hard disk drive 33 and uses the word list as the addition list for the copy-destination folder.

Description returns to that in FIG. 5.

The processor 31 updates a word list and attributes of a parent folder (Step 5).

After the process of Step 5, the processor 31 updates attributes of the target document (Step 6).

In this exemplary embodiment, a word list and attributes of a higher-level folder including the parent folder are determined with priority, and the attributes of the target document are determined in consideration of the determined word list and attributes of the higher-level folder.

Therefore, the attributes of the target document are determined in consideration of relative relationships with words appearing in other documents in the same parent folder and words appearing in all documents in the higher-level folder incorporating the parent folder.

After the process of Step 6, the processor 31 terminates the processing operations for the target document.

### <Processing Operations in Individual Steps>

### <Processing Operations in Step 5>

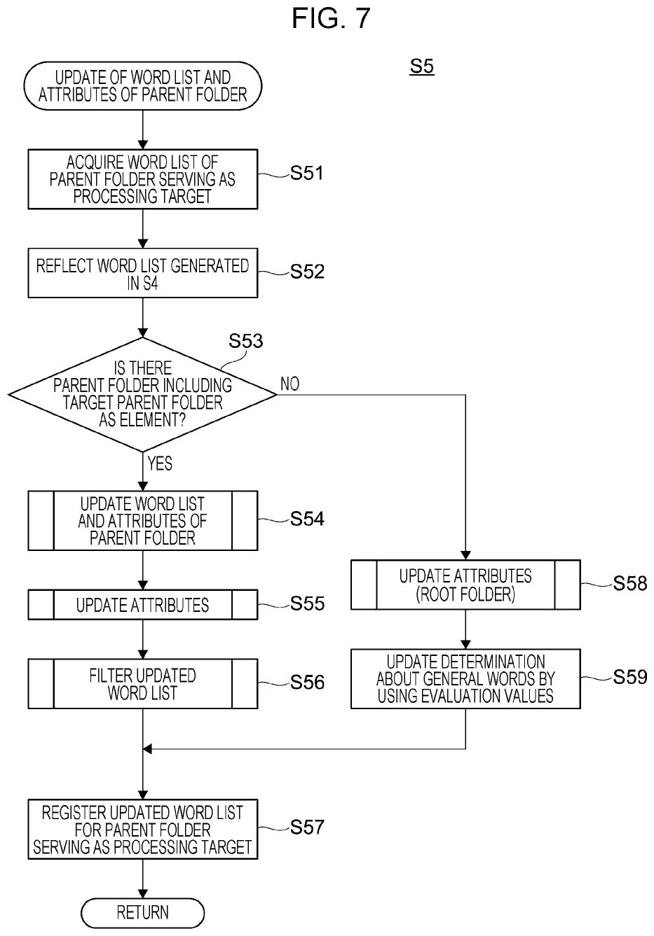

FIG. 7 is a flowchart illustrating an example of processing operations to be executed in Step 5.

In Step 5, word lists and attributes of the parent folder and a folder related to operation are updated. In this case, the parent folder includes not only the folder including the target document but also the higher-level folder incorporating the folder.

First, the processor 31 acquires the word list of the parent folder serving as a processing target (Step 51). As described above, the word list of the parent folder is stored in the hard disk drive 33.

After the word list is acquired, the processor 31 reflects the word list generated in Step 4 (see FIG. 5) in the acquired word list (Step 52). Specifically, the processor 31 acquires the increase list, the subtraction list, or the word addition/subtraction list.

Next, the processor 31 determines whether there is a parent folder incorporating the target parent folder (Step 53).

If the result is “YES” in Step 53, the processor 31 updates a word list and attributes of the parent folder (Step 54). Specifically, the processor 31 starts the processes from Step 51 on the higher-level folder incorporating the folder serving as the processing target.

Next, the processor 31 updates attributes of the parent folder serving as the processing target (Step 55).

Then, the processor 31 filters the updated word list (Step 56). Specifically, general words are excluded from the word list of the folder serving as the processing target. The general words are generated in Step 59 in which a root folder is a processing target.

Then, the processor 31 registers the updated word list for the parent folder serving as the processing target (Step 57).

If the result is “NO” in Step 53, the processor 31 recognizes that the folder serving as the processing target is the root folder, and updates attributes of the root folder (Step 58). The attributes of the root folder are determined by using a word list of the root folder. The word list of the root folder (hereinafter referred to also as “master word list”) includes words appearing in all documents belonging to the root folder, and all words appearing in all documents belonging to all folders included in the root folder.

The attributes of the root folder are determined by reflecting all the words appearing in all the documents.

Next, the processor 31 updates determination about the general words by using evaluation values (Step 59). In this exemplary embodiment, TF-IDF values are used as the evaluation values.

In this exemplary embodiment, the general words are words having low evaluation values. The general words are used in the filtering in Step 56.

In this exemplary embodiment, the processor 31 calculates TF-IDF values of the words in the master word list, and extracts words having low TF-IDF values as general words. For example, the processor 31 sets the general words to words having TF-IDF values lower than a preset threshold.

Then, the processor 31 registers the updated word list for the parent folder serving as the processing target (Step 57).

### <Processing Operations in Step 6, Step 55, and Step 58>

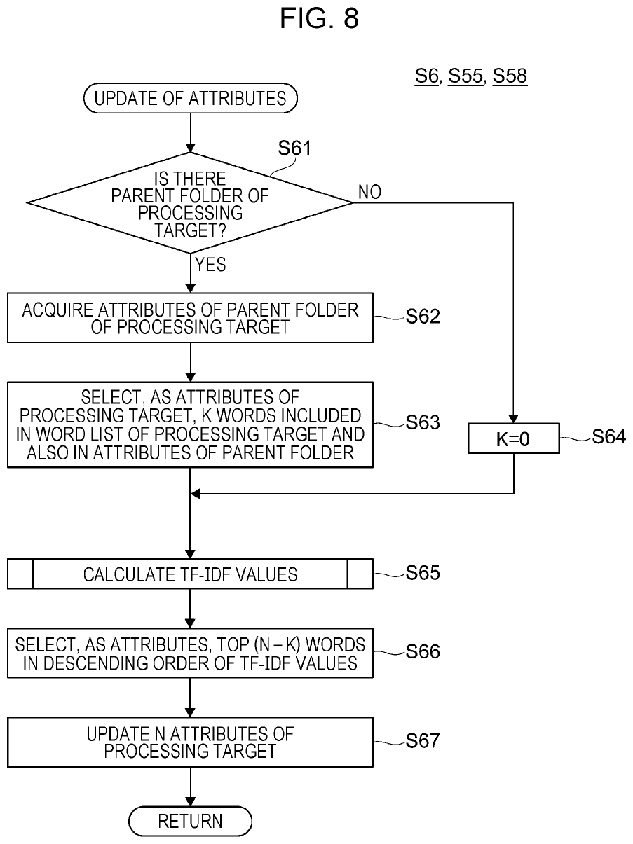

FIG. 8 is a flowchart illustrating an example of processing operations to be executed in Step 6 (see FIG. 5), Step 55 (see FIG. 7), and Step 58 (see FIG. 7). Step 6, Step 55, and Step 58 are hereinafter referred to also as “Step 6 etc.”

In Step 6 etc., attributes of a processing target are updated. In Step 6, the processing target is a document. In Step 55 and Step 58, the processing target is a folder. Specifically, the processing target of Step 58 is the root folder, and the processing target of Step 55 is a folder other than the root folder.

First, the processor 31 determines whether there is a parent folder of the processing target (Step 61).

If the result is “YES” in Step 61, the processor 31 acquires attributes of the parent folder of the processing target (Step 62). If the processing target is a document, attributes of a parent folder of the document are acquired. If the processing target is a folder, attributes of a parent folder of the folder are acquired.

Next, the processor 31 selects, as attributes of the processing target, K words included in a word list of the document or folder serving as the processing target and also in the attributes of the parent folder (Step 63). That is, K words belonging to both the word list of the parent folder and the word list of the processing target are selected as the attributes of the processing target.

The value K is given in advance. The value K may be a fixed value or given by, for example, an administrator of the document management system 30 (see FIG. 1). If the administrator may set the value K, the value K may be changed later.

In this exemplary embodiment, the attributes of the document or folder serving as the processing target reflect the attributes of a folder that is one level higher than and incorporates the processing target (i.e., the parent folder of the processing target).

If the result is “NO” in Step 61, the processor 31 sets the value K to 0 (zero) (Step 64).

After Step 63 or Step 64, the processor 31 calculates TF-IDF values (Step 65).

Then, the processor 31 selects, as the attributes, top (N−K) words in descending order of the TF-IDF values (Step 66). The value N is given in advance. The value N is larger than the value K. The value N may be a fixed value or given by, for example, the administrator of the document management system 30 (see FIG. 1). If the administrator may set the value N, the value N may be changed later.

If the processing target is the root folder, K is set to 0 in Step 64. Therefore, N words are selected as the attributes.

Then, the processor 31 updates the N attributes of the processing target (Step 67).

### <Processing Operations in Step 65>

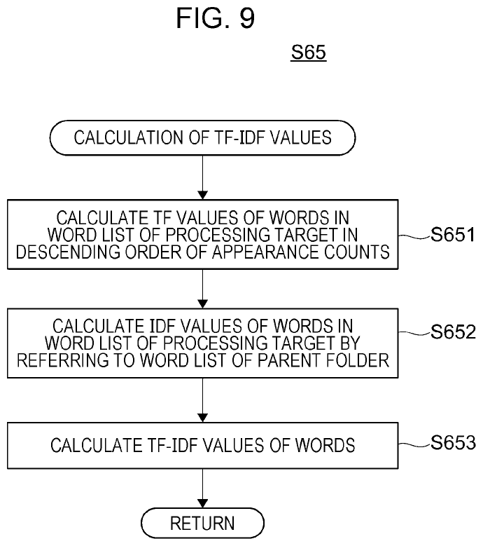

FIG. 9 is a flowchart illustrating an example of processing operations to be executed in Step 65 (see FIG. 8).

In Step 65, TF-IDF values are calculated.

First, the processor 31 calculates TF values of words in the word list of the processing target in descending order of appearance counts (Step 651).

Next, the processor 31 calculates IDF values of the words in the word list of the processing target by referring to the word list of the parent folder (Step 652). That is, the IDF values of the words in the word list of the processing target are calculated by grasping, in the word list of the parent folder, (1) the total number of documents in the parent folder and (2) the number of documents including the words appearing in the processing target.

If the processing target is the root folder, no parent folder exists. Therefore, the IDF values are calculated from the word list of the root folder. That is, the IDF values of the words are calculated based on the total number of documents in the root folder and the number of documents including the words in the root folder.

After the TF values and the IDF values are calculated, the processor 31 calculates TF-IDF values of the words (Step 653).

In this exemplary embodiment, the TF-IDF values are calculated for all the words in the word list. When the TF-IDF values of the N words are calculated in descending order of the appearance counts, the calculation of the TF-IDF values of succeeding words may be stopped because only the N words are used in Step 66 (see FIG. 8).

### <Processing Operations in Step 56>

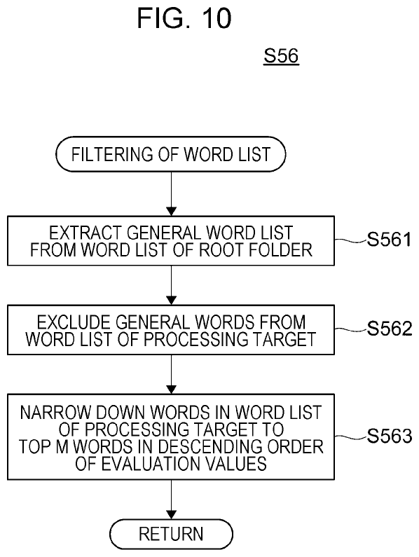

FIG. 10 is a flowchart illustrating an example of processing operations to be executed in Step 56 (see FIG. 7).

In Step 56, a word list is filtered. In other words, the number of words in the word list is reduced.

First, the processor 31 extracts the general words from the word list of the root folder (Step 561).

Next, the processor 31 excludes the general words from the word list of the processing target (Step 562).

Then, the processor 31 narrows down the words in the word list of the processing target to top M (>N) words in descending order of the evaluation values (Step 563). The top M words are set to include the N words to be selected as the attributes even if the document serving as the processing target is modified.

### <Processing Flow>

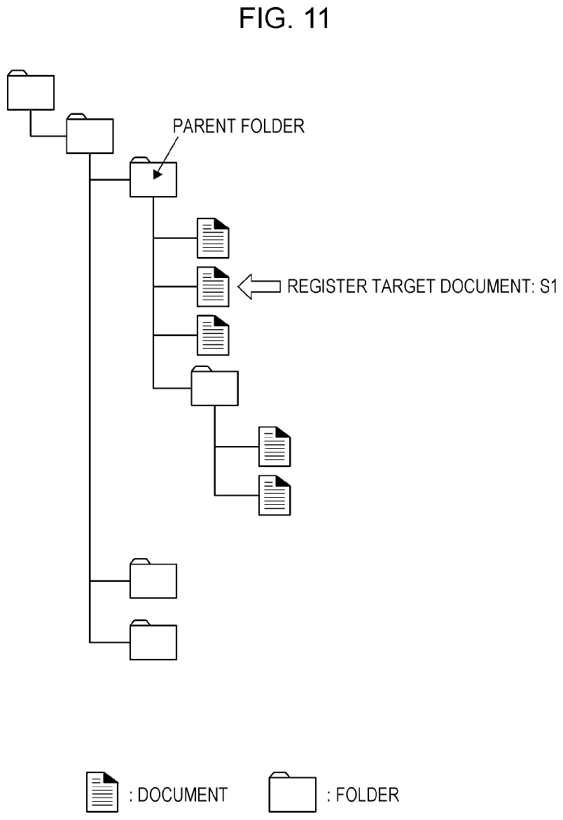

A flow of assignment of attributes in this exemplary embodiment is schematically described below with reference to FIG. 11 to FIG. 17.

FIG. 11 conceptually demonstrates a processing operation corresponding to Step 1 (see FIG. 5). In FIG. 11, two documents and one folder have already been registered in a parent folder of a target document.

In FIG. 11, the parent folder is positioned at the third level. Therefore, the folder in the parent folder is positioned at a fourth level. Two documents are registered in the folder at the fourth level. Therefore, the word list of the parent folder includes all words appearing in a total of five documents. After the filtering, the number of words is reduced to N.

### <Process 1>

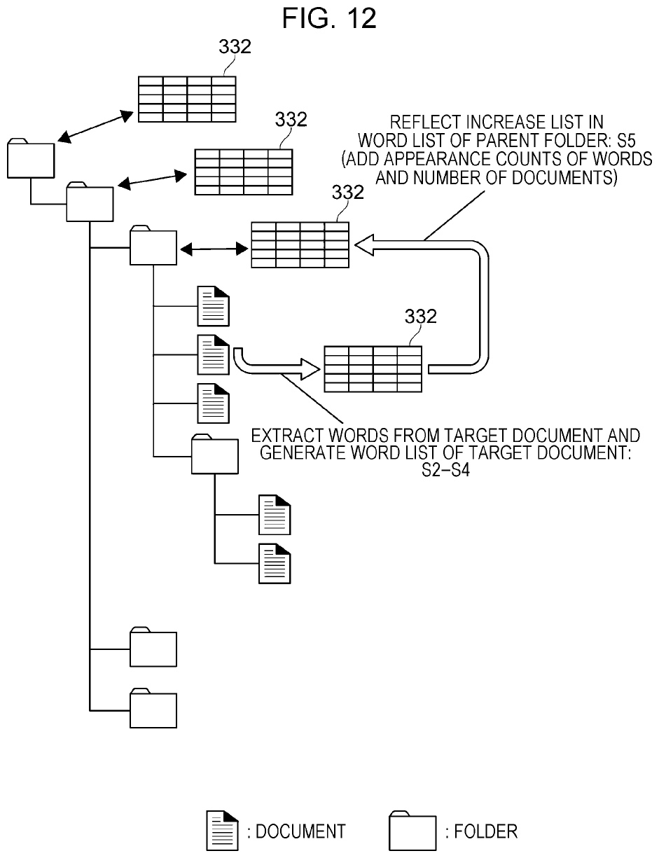

FIG. 12 conceptually demonstrates processing operations corresponding to Step 2 to Step 5 (see FIG. 5) according to the first exemplary embodiment. In FIG. 12, it is assumed, to facilitate the description, that the parent folder including the target document is a root folder in a reference range for assignment of attributes to the target document.

In response to registration of a document, words are first extracted from the target document, and a word list of the target document is generated. Those processing operations correspond to Step 2 to Step 4 (see FIG. 5).

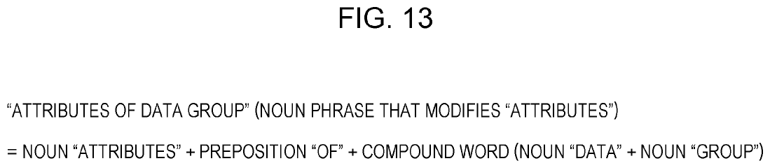

FIG. 13 illustrates an example of the extracted words. The words illustrated in FIG. 13 are an example of a noun phrase constituted by a noun “attributes”, a preposition “of”, and a compound word “data group”.

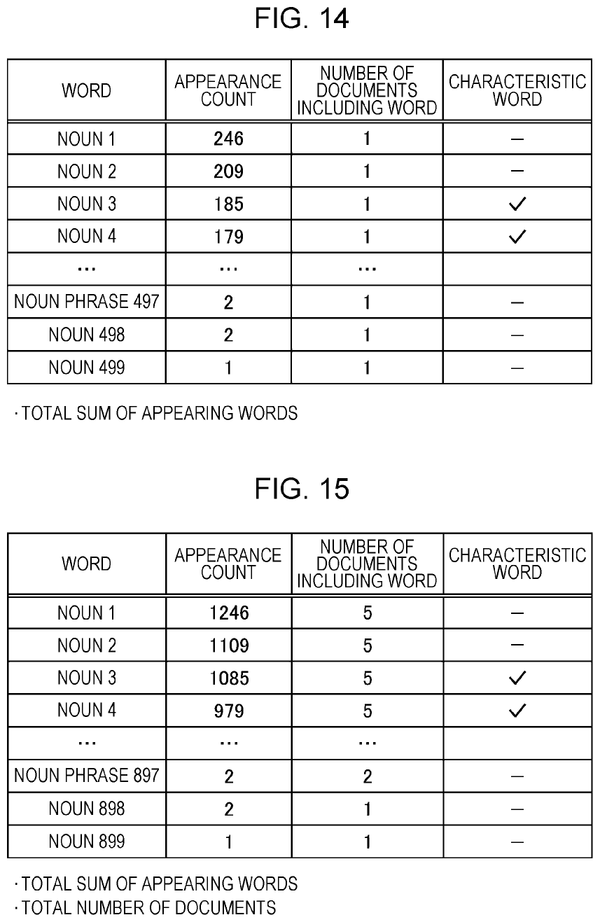

FIG. 14 illustrates an example of the structure of a word list generated for a document. The word list has items for a word, an appearance count, the number of documents including the word, a result of determination about a characteristic word, and the total sum of words appearing in the document (hereinafter referred to as “total sum of appearing words”).

In FIG. 14, 499 words are extracted from the target document. Each word is linked to a result of measurement of a count of appearance in the target document. In the case of the word list of the document, all the numbers of documents including words are “1”. This is a difference from a word list of a folder.

The total sum of appearing words is the sum of the appearance counts of all the words in the document.

Description returns to that in FIG. 12.

The word list of the document is added to the word list of the parent folder. In FIG. 12, an arrow from the word list of the document to the word list of the parent folder indicates how the word list is added. This processing operation corresponds to Step 5 (see FIG. 5).

If a document is newly registered, the word list of the document is given to the parent folder as an increase list. Thus, the word list of the parent folder is updated. Specifically, appearance counts of words and the number of documents are added.

FIG. 15 illustrates an example of the structure of a word list generated for a parent folder. The word list of the parent folder has items for a word, an appearance count, the number of documents including the word, a result of determination about a characteristic word, the total sum of appearing words, and the total number of documents.

The word list illustrated in FIG. 15 is the word list of the parent folder at the third level. The word list includes 899 words extracted from the five documents in the parent folder.

The maximum value of the appearance count indicating the number of documents including each word is “5” because the parent folder includes five documents. The total number of documents is also “5”.

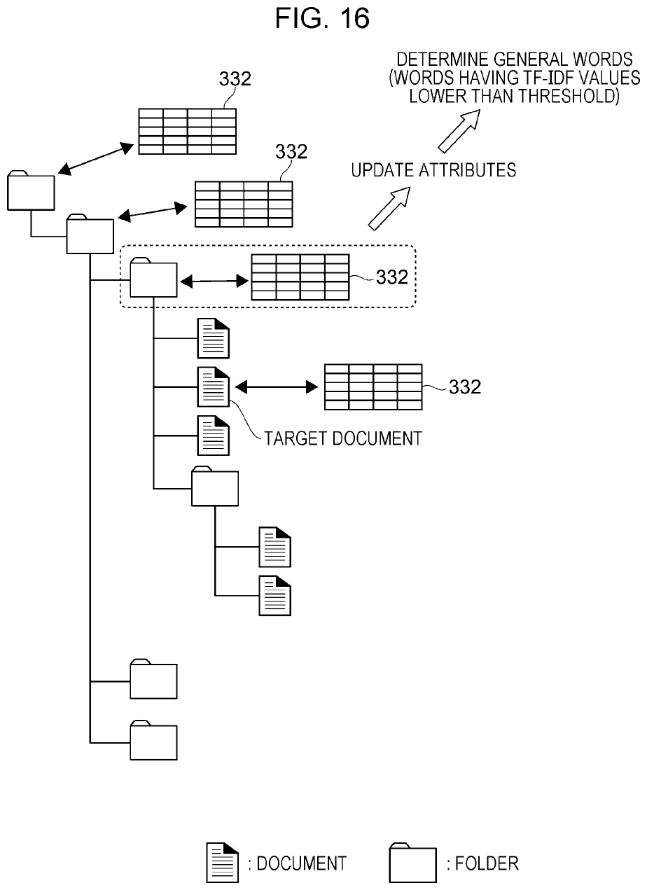

FIG. 16 conceptually demonstrates processing operations corresponding to Step 57 to Step 59 (see FIG. 7) according to the first exemplary embodiment.

As illustrated in FIG. 16, in response to the addition of the word list of the target document to the word list of the parent folder, attributes are updated and general words are determined for the parent folder serving as the root folder.

Specifically, N words are extracted in descending order of TF-IDF values from all the words in the updated word list of the parent folder, and the attributes of the root folder are determined. That is, the attributes are updated.

Next, words having TF-IDF values lower than the threshold among the words in the word list of the parent folder are determined as the general words.

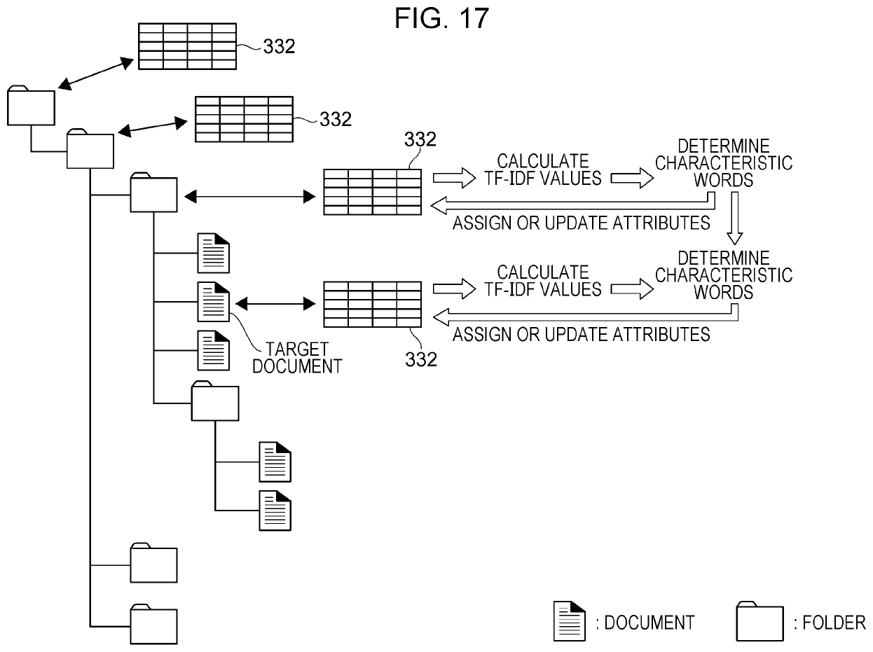

FIG. 17 conceptually demonstrates processing operations corresponding to Step 54 to Step 57 (see FIG. 7) according to the first exemplary embodiment.

After the attributes assigned to the root folder are updated and the general words are determined, attributes of a higher-level folder other than the root folder are updated and the word list of the higher-level folder is filtered. In this exemplary embodiment, this process is not executed because the root folder is the parent folder of the target document. Eventually, attributes to be assigned to the target document are updated.

In this exemplary embodiment, the word list of the target document is not stored. Therefore, attributes are only assigned to the target document, and the word list is not filtered.

After the TF-IDF values of the words in the word list are calculated, the attributes are assigned by determining characteristic words in descending order of the TF-IDF values.

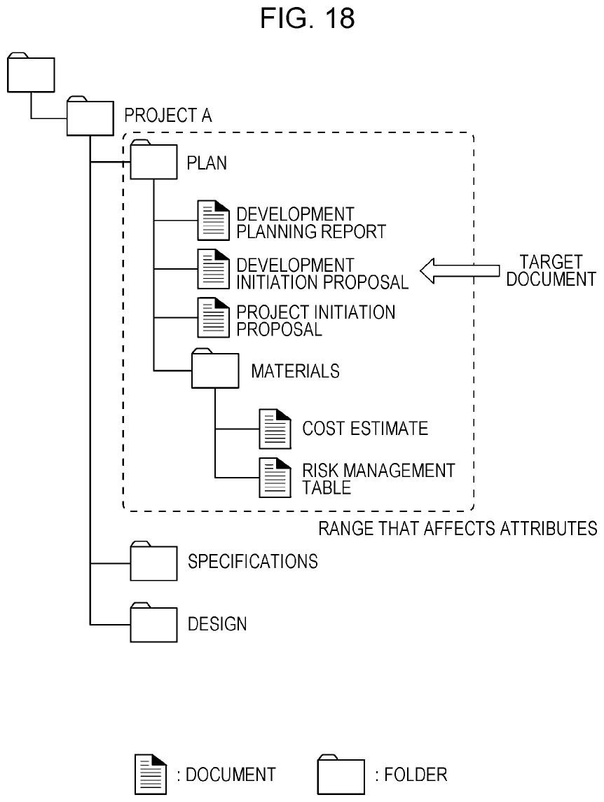

FIG. 18 illustrates a range that affects the attributes of the target document according to the first exemplary embodiment. In FIG. 18, the target document is a “development initiation proposal” belonging to a “Plan” folder.

The “Plan” folder is an example of the first group.

A “development planning report” and a “project initiation proposal” belonging to the same folder and a “cost estimate” and a “risk management table” belonging to a folder at a lower level constitute a group of documents in the “Plan” folder serving as the first group, and are counted as the total number of documents in the first group.

TF values calculated for words appearing in the group of documents belonging to the “Plan” folder are examples of the third characteristic value.

In this exemplary embodiment, the attributes of the target document are, as described above, the N words including the K words included in both the word list of the parent folder including the target document and the word list of the target document and the top (N−K) words in the word list of the parent folder in descending order of the TF-IDF values.

The words in the word list of the parent folder are a group of words appearing in the five documents within a range enclosed by a broken line.

In this exemplary embodiment, the attributes assigned to the target document are not only the words in the word list of the target document but also the words in the word list of the parent folder.

The attributes assigned to the target document are examples of a first attribute.

In this exemplary embodiment, the word list of the document is generated when attributes are assigned or when attributes may be changed, but the word list is not stored after the attributes are assigned.

In the word list of the higher-level folder including the parent folder, only the top M (>N) words in descending order of the evaluation values such as the TF-IDF values are stored in the hard disk drive 33 with the general words excluded.

If the TF value of a word at the bottom of the word list of each higher-level folder after the update is higher than the TF value of an n-th word from the top of the word list before the update, the word lists of all the documents belonging to the folder are created again.

### <Process 2>

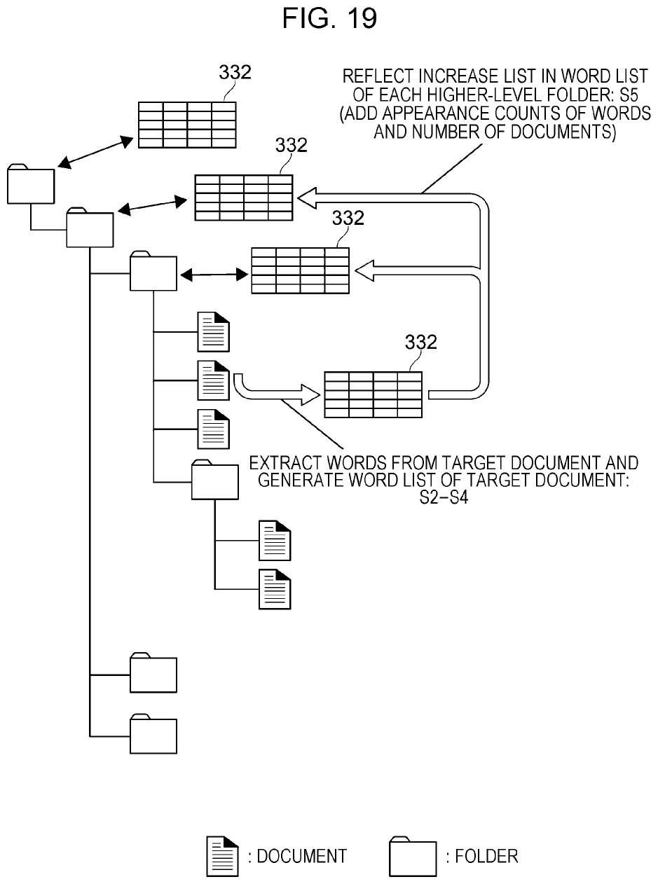

FIG. 19 conceptually demonstrates other processing operations corresponding to Step 2 to Step 5 (see FIG. 5) according to the first exemplary embodiment. In FIG. 19, parts corresponding to those in FIG. 12 are represented by the same reference symbols.

In FIG. 19, it is assumed that a folder that is one level higher than the parent folder including the target document (i.e., a folder that is two levels higher than the target document) is the root folder in the reference range for assignment of attributes to the target document.

Therefore, the word list generated along with the registration of the target document is reflected, as an increase list, in the word lists of the parent folder and the folder that is one level higher than the parent folder (i.e., the folder that is two levels higher than the target document). The generated word list may be reflected in a folder at an even higher level.

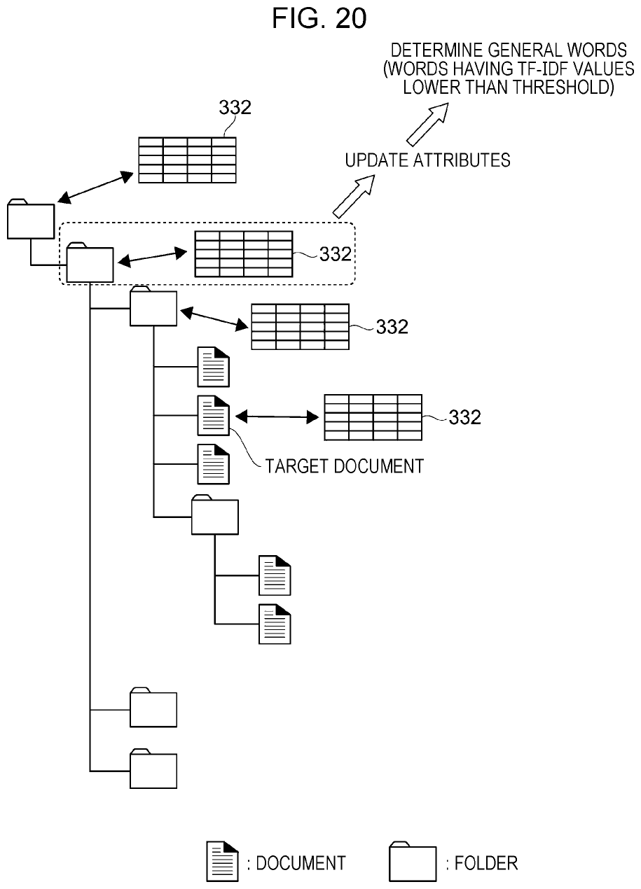

FIG. 20 conceptually demonstrates other processing operations corresponding to Step 57 to Step 59 (see FIG. 7) according to the first exemplary embodiment. In FIG. 20, parts corresponding to those in FIG. 16 are represented by the same reference symbols.

In FIG. 20, a parent folder of the parent folder including the target document is the root folder in the reference range for assignment of attributes to the target document. Therefore, attributes are updated and general words are determined for a word list of a folder that is one level higher than in the case of FIG. 16.

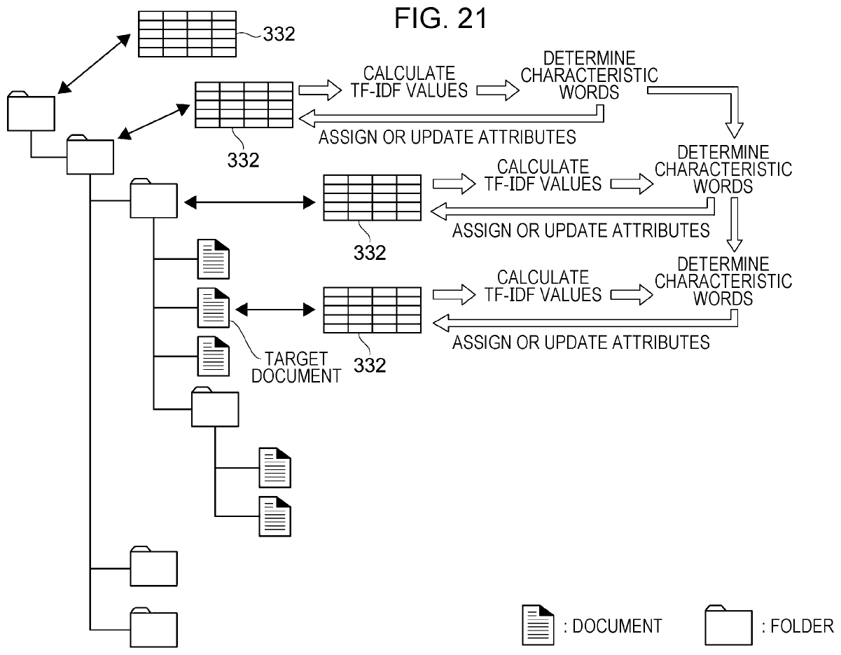

FIG. 21 conceptually demonstrates other processing operations corresponding to Step 54 to Step 57 (see FIG. 7) according to the first exemplary embodiment. In FIG. 21, parts corresponding to those in FIG. 17 are represented by the same reference symbols.

In FIG. 21, after attributes are assigned to a higher-level folder that is one level higher than the parent folder, attributes are assigned and general words are filtered out of the word list of the parent folder. Lastly, normal attributes are assigned to the target document.

### Second Exemplary Embodiment

In the first exemplary embodiment, the group of documents belonging to the parent folder of the processing target is in the range of IDF calculation for words appearing in the processing target (i.e., words in the word list of the processing target). In a second exemplary embodiment, a group of documents belonging to a folder at an even higher level is set in the range of IDF calculation.

For example, if the parent folder is set in the range of IDF calculation, words related to a plan, such as “schedule” and “cost”, appear in many documents belonging to the “Plan” folder serving as the parent folder. Therefore, the IDF values of those words decrease and other words may be assigned as the attributes of the target document. As a result, the documents belonging to the “Plan” folder are not hit even though the words such as “schedule” and “cost” are used as search keys.

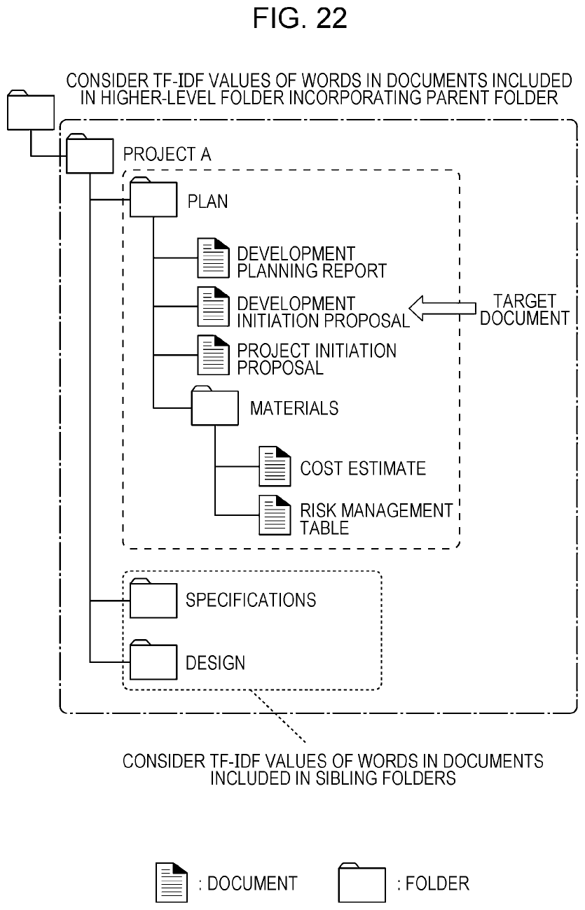

FIG. 22 illustrates a range that affects the attributes of the target document according to the second exemplary embodiment. The directory structure of FIG. 22 is identical to the directory structure of FIG. 18.

In this exemplary embodiment, a group of documents in a “Project A” folder incorporating the “Plan” folder serving as the parent folder of the target document is set in the range of calculation of the IDF values of the words appearing in the target document.

The “Project A” folder is an example of a second group. Documents belonging to a “Specifications” folder and a “Design” folder belonging to the “Project A” folder constitute a group of documents in the “Project A” folder serving as the second group, and are counted as the total number of documents in the second group. It is expected that the group of documents belonging to the “Specifications” folder and the “Design” folder separate from the “Plan” folder includes few documents including the words related to the plan, such as “schedule” and “cost”.

In view of the entire group of documents belonging to the “Project A” folder (i.e., the total number of documents), the ratio of the number of documents including the words such as “schedule” and “cost” decreases.

The TF values of the words appearing in the target document are calculated based on the frequencies of appearance of the words in the target document. That is, the range of calculation of the IDF values (i.e., the folder at a higher level than the parent folder of the target document) is two or more levels higher than the range of calculation of the TF values (i.e., the target document).

### Third Exemplary Embodiment

In the first and second exemplary embodiments, the attributes of the processing target are selected from among the words appearing in the processing target as in Steps 63, 65, and 66 of FIG. 8.

In a third exemplary embodiment, words that do not appear in the processing target but are selected as attributes of higher-level folders (i.e., including the parent folder) are also selected as the attributes of the processing target. For example, if the processing target is a document, words that do not appear in the target document but are assigned as the attributes of the parent folder are transferred as the attributes of the target document.

In this exemplary embodiment, a term “virtual” means that the attribute is not fixed to the target document.

A “fixed” attribute moves together with the target document in response to movement of the target document to a different folder. A “virtual” attribute depends on relationships with higher-level folders or sibling folders. Therefore, in response to a change of a higher-level folder or a sibling folder related to the target document, the “virtual” attribute is temporarily deleted from and newly assigned to the target document.

### <System and Device Configurations>

Also in this exemplary embodiment, the network system 1 illustrated in FIG. 1 is used. In this exemplary embodiment, the function described above is added to the document management system 30.

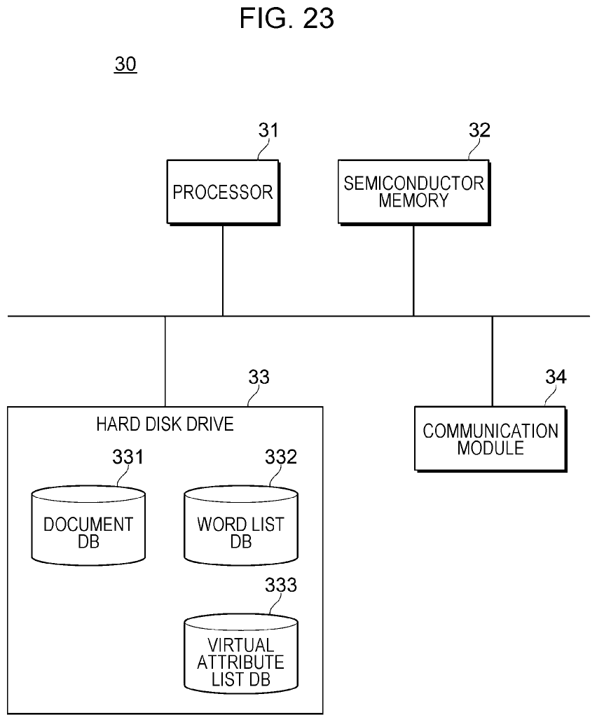

FIG. 23 illustrates an example of the hardware configuration of the document management system 30 according to the third exemplary embodiment. In FIG. 23, parts corresponding to those in FIG. 2 are represented by the same reference symbols.

The third exemplary embodiment differs from the first exemplary embodiment in that the hard disk drive 33 illustrated in FIG. 23 stores a database 333 that stores a virtual attribute list (hereinafter referred to as “virtual attribute list DB”).

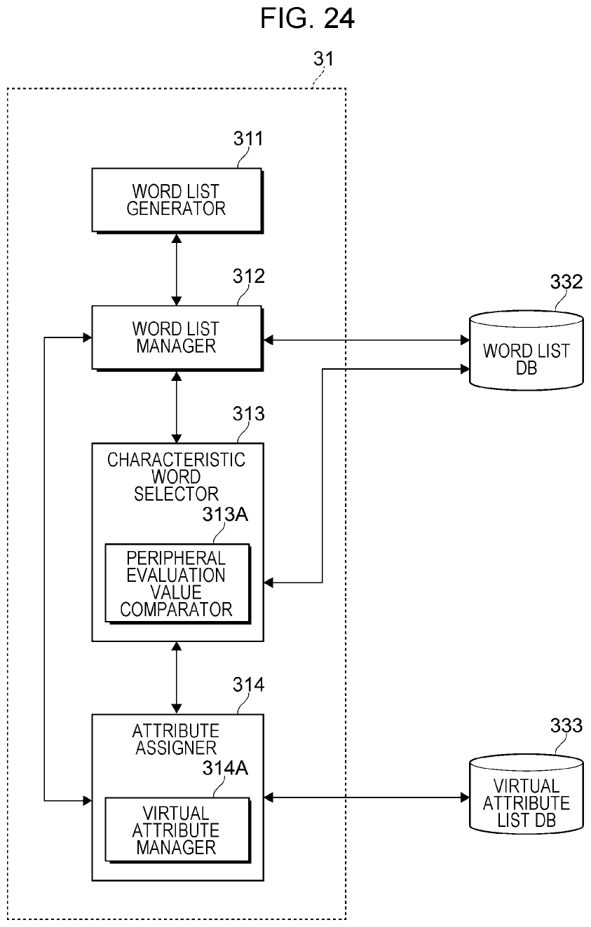

FIG. 24 illustrates a part of functions implemented by the processor 31 according to the third exemplary embodiment. In FIG. 24, parts corresponding to those in FIG. 3 are represented by the same reference symbols.

The functional configuration of FIG. 24 is similar to the functional configuration of FIG. 3, and a new subfunction is added to the characteristic word selector 313.

Specifically, a peripheral evaluation value comparator 313A is added to the characteristic word selector 313.

The peripheral evaluation value comparator 313A calculates IDF values of words in the word lists of the parent folder including the target document and its higher-level folder.

As described above, words may be biased in a folder including documents collected based on a certain common matter, and IDF values in its parent folder decrease. As a result, the IDF values may decrease even if the frequencies of appearance of the words are high. Therefore, there is a possibility that the words to be assigned as attributes are not locally extracted as characteristic words.

In this exemplary embodiment, the peripheral evaluation value comparator 313A is added to expand the reference range for assignment of attributes to the target document.

A virtual attribute manager 314A is added to the attribute assigner 314 illustrated in FIG. 24 as a new subfunction.

The virtual attribute manager 314A manages virtual attributes transferred from higher-level folders including the parent folder while distinguishing the virtual attributes from the attributes selected from among the words appearing in the processing target (hereinafter referred to also as “normal attributes”). That is, the virtual attributes and the normal attributes of the target document are managed while being distinguishable from each other.

As described above, the virtual attribute is not fixed to the target document. That is, the virtual attribute depends on the higher-level folder of the parent folder. In response to a change of the higher-level folder by movement or copying of the target document, new virtual attributes are assigned depending on a movement-destination or copy-destination folder.

The peripheral evaluation value comparator 313A also assigns characteristic words extracted by expanding the reference range to the target document as attributes. Similarly to the attributes in the range of the parent folder, those attributes may be used as search keys or viewed by displaying properties of the target document.

Unlike the normal attributes, the virtual attributes of the target document are prohibited from being edited, for example, rewritten into other words. The words assigned as the virtual attributes may be edited as attributes of a folder related to the target document.

In this exemplary embodiment, the words managed as the virtual attributes by the virtual attribute manager 314A do not overlap the words managed as the normal attributes.

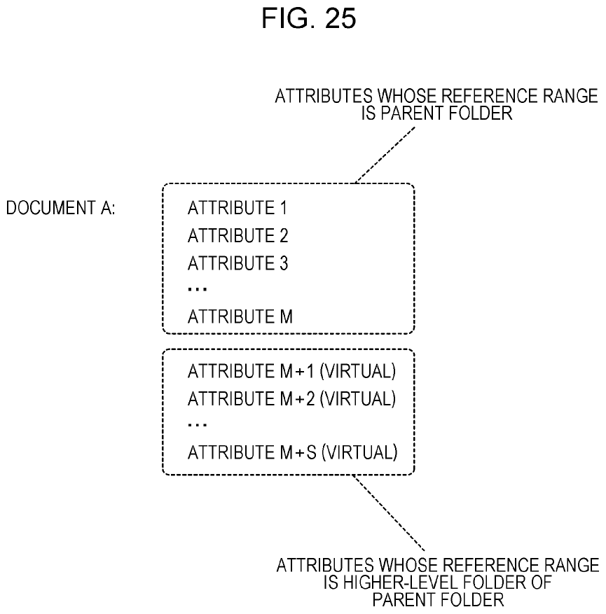

FIG. 25 illustrates the virtual attributes assigned to the target document.

In FIG. 25, a document A has M+S attributes. Attributes 1 to M are normal attributes whose reference range is the parent folder. Attributes M+1 to M+S are virtual attributes whose reference range is a higher-level folder of the parent folder. That is, the attributes 1 to M are examples of the first attribute, and the attributes M+1 to M+S are examples of a second attribute.

In FIG. 25, texts “virtual” are combined with the virtual attributes M+1 to M+S, but this type of information is not attached to the normal attributes 1 to M. In this exemplary embodiment, the types of the attributes are distinguished based on whether the text “virtual” is attached.

The virtual attribute manager 314A (see FIG. 24) of this exemplary embodiment also has a function of receiving settings on transfer of virtual attributes.

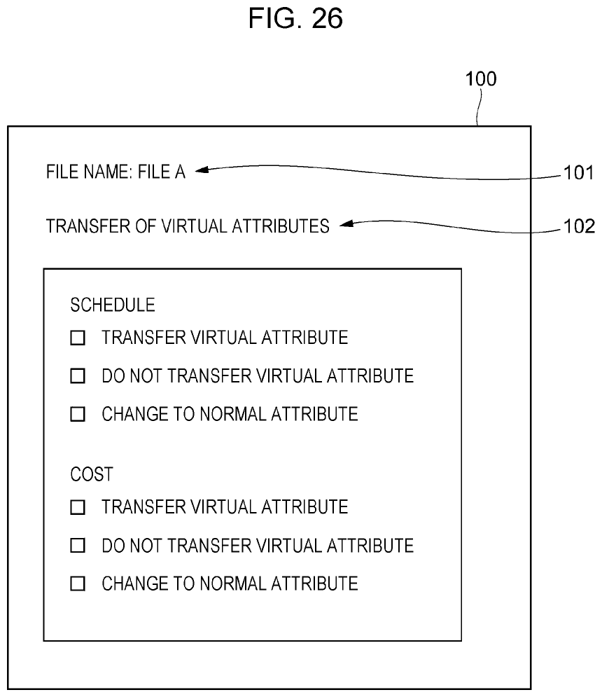

FIG. 26 illustrates an example of a screen 100 to be presented to a user when moving or copying the target document to a different folder.

Although the editing of the virtual attributes is not permitted as described above, the user may give an instruction to transfer the virtual attributes.

The check screen 100 illustrated in FIG. 26 has a display field 101 for a file name of the target document, and a setting field 102 for an instruction to transfer the virtual attributes assigned to the target document.

In this exemplary embodiment, “schedule” and “cost” are shown as examples of the virtual attributes.

In FIG. 26, options “Transfer virtual attribute”, “Do not transfer virtual attribute”, and “Change to normal attribute” are prepared for each virtual attribute.

As described above, the virtual attribute depends on higher-level folders or sibling folders of the parent folder. Basically, the existing virtual attribute is deleted and a new virtual attribute is assigned along with movement or copying.

If the virtual attribute accurately shows the contents of the target document, the user may wish to leave the virtual attribute as it is.

In FIG. 26, an option of leaving the virtual attribute as it is and an option of changing the virtual attribute to a normal attribute are prepared as options to leave the existing virtual attribute. An option of avoiding the transfer of the virtual attribute is provided as well.

### <Processing Flow>

Processing operations unique to this exemplary embodiment are described below.

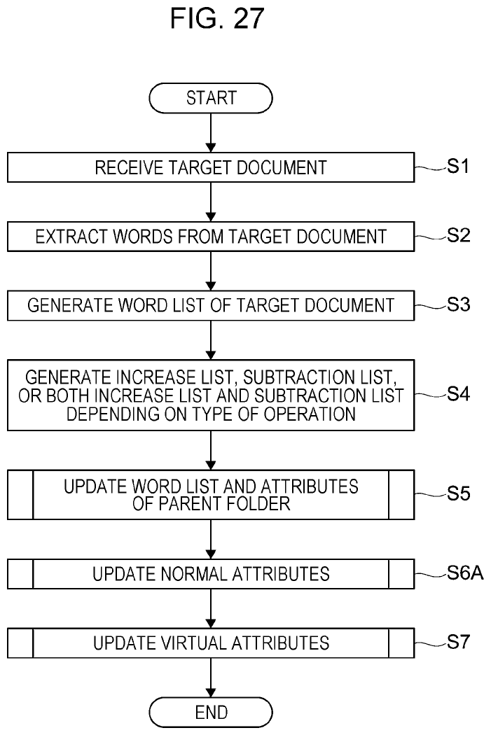

FIG. 27 is a flowchart illustrating an example of processing operations of the virtual attribute manager 314A (see FIG. 24) according to the third exemplary embodiment. In FIG. 27, parts corresponding to those in FIG. 5 are represented by the same reference symbols.

Among the processing operations of the virtual attribute manager 314A, operations up to Step 5 are identical to the processing operations illustrated in FIG. 5.

After the process of Step 5, the processor 31 updates normal attributes of the target document (Step 6A). As described above, the normal attributes are attributes selected from among the words appearing in the processing target.

Then, the processor 31 updates virtual attributes of the target document (Step 7).

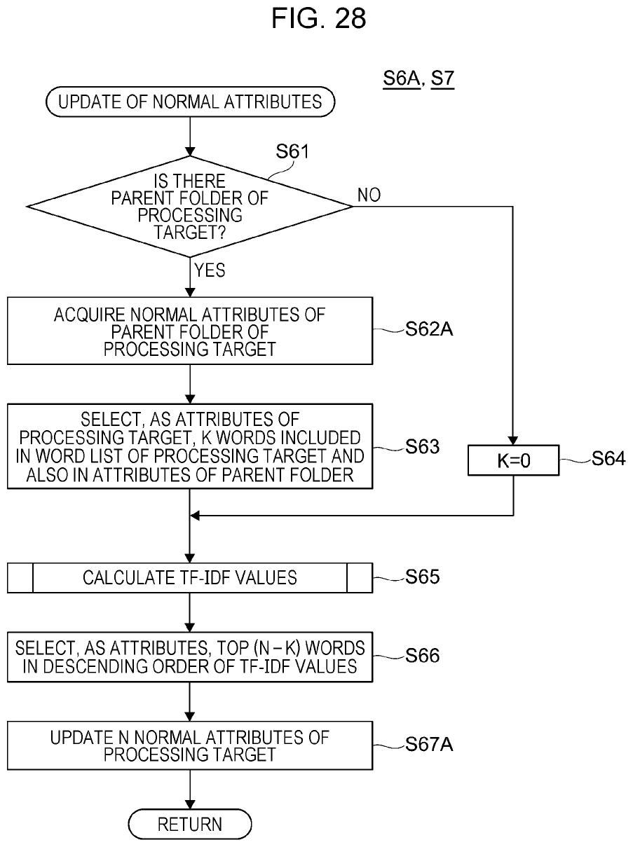

FIG. 28 is a flowchart illustrating an example of processing operations to be executed in Step 6A and Step 7 (see FIG. 27). In FIG. 28, parts corresponding to those in FIG. 8 are represented by the same reference symbols. Step 6A and Step 7 are hereinafter referred to collectively as “Step 6A etc.”

The processing operations to be executed in Step 6A etc. are basically similar to the processing operations illustrated in FIG. 8.

First, the processor 31 determines whether there is a parent folder of the processing target (Step 61).

If the result is “YES” in Step 61, the processor 31 acquires normal attributes of the parent folder of the processing target (Step 62A). If the processing target is a document, normal attributes of a parent folder of the document are acquired. If the processing target is a folder, normal attributes of a parent folder of the folder are acquired.

In the case of updating virtual attributes in Step 7 (see FIG. 27), the processor 31 acquires virtual attributes of the parent folder of the processing target in Step 62A.

Next, the processor 31 selects, as attributes of the processing target, K words included in a word list of the document or folder serving as the processing target and also in the attributes of the parent folder (Step 63). That is, K words belonging to both the word list of the parent folder and the word list of the processing target are selected as the attributes of the processing target.

The value K is given in advance. The value K may be a fixed value or given by, for example, the administrator of the document management system 30 (see FIG. 1). If the administrator may set the value K, the value K may be changed later.

In this exemplary embodiment, the attributes of the document or folder serving as the processing target reflect the attributes of a folder that is one level higher than and includes the processing target (i.e., the parent folder of the processing target).

If the result is “NO” in Step 61, the processor 31 sets the value K to 0 (zero) (Step 64).

After Step 63 or Step 64, the processor 31 calculates TF-IDF values (Step 65).

Then, the processor 31 selects, as the attributes, top (N−K) words in descending order of the TF-IDF values (Step 66). The value N is given in advance. The value N is larger than the value K. The value N may be a fixed value or given by, for example, the administrator of the document management system 30 (see FIG. 1). If the administrator may set the value N, the value N may be changed later.

If the processing target is the root folder, K is set to 0 in Step 64. Therefore, N words are selected as the attributes.

Then, the processor 31 updates the N normal attributes of the processing target (Step 67A). In the case of updating virtual attributes in Step 7 (see FIG. 27), the processor 31 updates the virtual attributes of the parent folder of the processing target in Step 67A.

In Step 63 of FIG. 28, the limitation “in word list of processing target” may be removed and the K words included in the attributes of the parent folder may be selected irrespective of whether the words are included in the word list of the processing target. In this case, words that do not appear in the processing target may be selected as a result.

Alternatively, a process of transferring the virtual attributes of the parent folder that are not included in the word list of the processing target may be executed separately while leaving the process of Step 63.

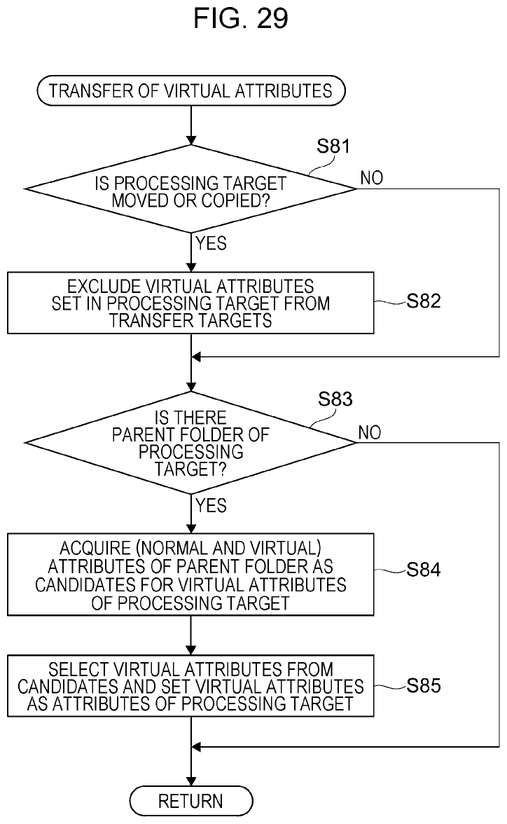

FIG. 29 is a flowchart illustrating an example of processing operations for transferring the virtual attributes of the parent folder.

First, the processor 31 determines whether the processing target is moved or copied (Step 81).

If the result is “YES” in Step 81, the processor 31 excludes the virtual attributes set in the processing target from transfer targets (Step 82).

After Step 82 is executed or if the result is “NO” in Step 81, the processor 31 determines whether there is a parent folder of the processing target (Step 83).

If the result is “YES” in Step 83, the processor 31 acquires (normal and virtual) attributes of the parent folder as candidates for virtual attributes of the processing target (Step 84).

Next, the processor 31 selects virtual attributes from the candidates and sets the virtual attributes as attributes of the processing target (Step 85). The virtual attributes are selected in accordance with the following rules. First, attributes included in the normal attributes of the processing target are not selected as the virtual attributes. If the number of attributes is limited, the attributes are narrowed down by using evaluation values or the like.

### <Processing Flow>

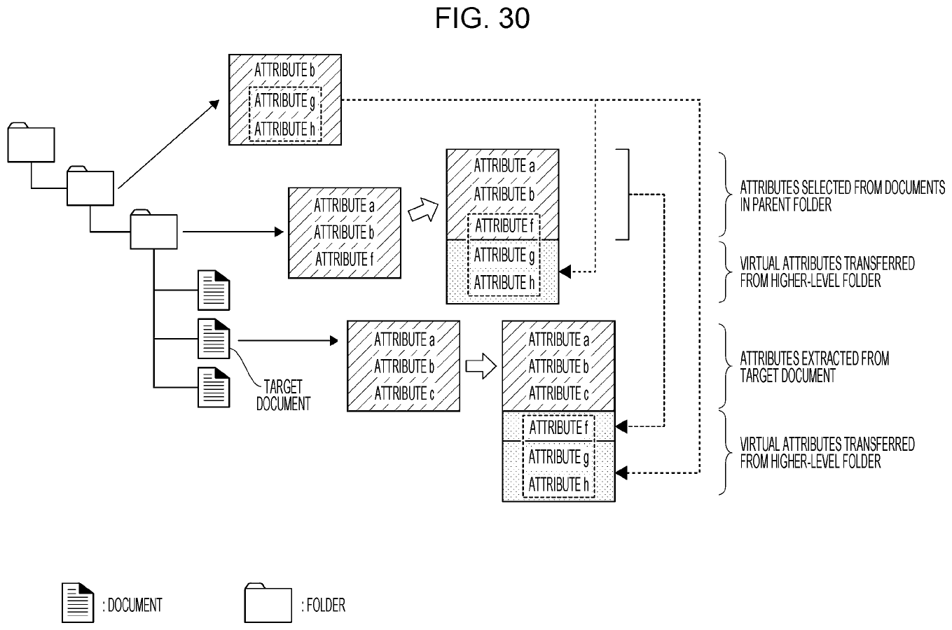

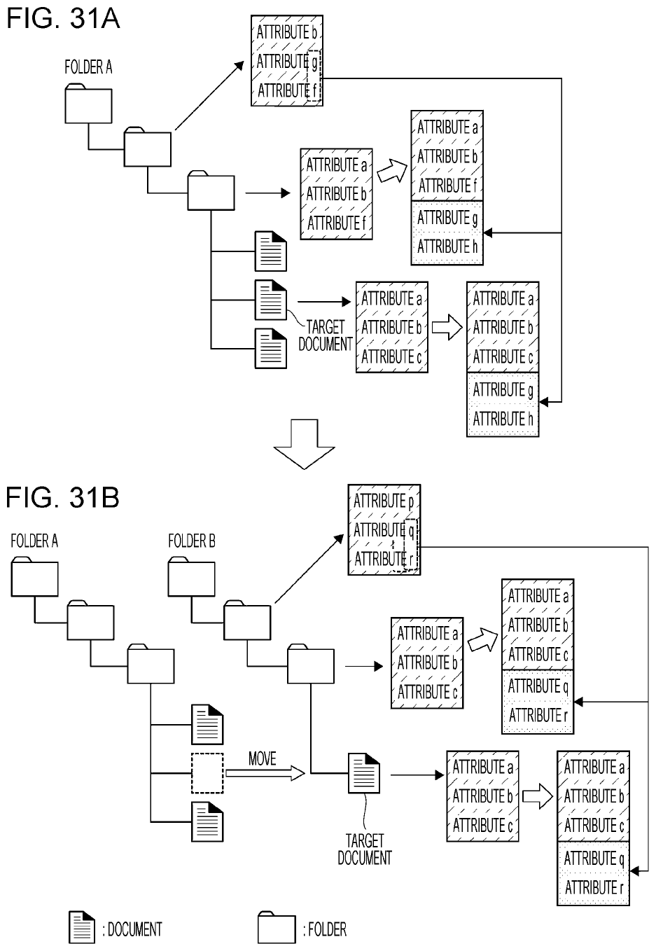

A flow of transfer of virtual attributes in this exemplary embodiment is schematically described below with reference to FIGS. 30, 31A, and 31B.

FIG. 30 illustrates how virtual attributes are assigned. FIG. 30 illustrates a case where virtual attributes to be assigned to the target document are transferred separately from a plurality of higher-level folders.

In FIG. 30, three normal attributes that are an “attribute b”, an “attribute g”, and an “attribute h” are assigned to a folder that is two levels higher than the target document.

The “attribute g” and the “attribute h” are transferred as virtual attributes of the parent folder and the target document. In this exemplary embodiment, two attributes whose appearance counts are larger than a threshold are transferred from among the three attributes. A predetermined number of attributes having relatively large appearance counts may be transferred instead of using the threshold.

Three normal attributes that are an “attribute a”, an “attribute b”, and an “attribute f” are assigned to the parent folder.

The “attribute f” is transferred as a virtual attribute of the target document.

As a result, normal attributes that are an “attribute a”, an “attribute b”, and an “attribute c” and virtual attributes that are the “attribute f”, the “attribute g”, and the “attribute h” are assigned to the target document.

As exemplified in FIG. 30, the virtual attributes are transferred from the higher level to the lower level by any one of the following methods. In the first method, the virtual attributes are transferred to the folder and to the target document. In the second method, the virtual attributes transferred to the parent folder from its higher-level folder are transferred to the target document.

The number of assignable virtual attributes may be limited.

In the case where the virtual attributes are transferred from the folder at a level higher than the parent folder as illustrated in FIG. 30, the reference range of hierarchical levels may be limited.

In a case where virtual attributes are transferred from sibling folders of the parent folder, the number of transfer-source sibling folders may be limited.

Similarly, an upper limit may be provided to the number of normal attributes to be assigned to the folder or the target document. Further, an upper limit may be provided to the total of the normal attributes and the virtual attributes.

FIGS. 31A and 31B illustrate changes of virtual attributes when a target document having the virtual attributes is moved to a different folder. FIG. 31A illustrates an example of the virtual attributes before the movement. FIG. 31B illustrates an example of the virtual attributes after the movement.

In FIGS. 31A and 31B, the target document before the movement is in a folder at a third level of a hierarchy in which a folder A is a root folder, whereas the target document after the movement is in a folder at a third level of a hierarchy in which a folder B is a root folder.

An “attribute g” and an “attribute h” are transferred as virtual attributes from a parent folder of the parent folder to the target document before the movement. In the target document after the movement, the virtual attributes are changed to an “attribute q” and an “attribute r” that reflect a movement-destination folder structure.

As described above, a part of the virtual attributes before the movement may continuously be assigned to the target document after the movement as normal attributes.

### Other Exemplary Embodiments

(1) In the exemplary embodiments described above, the TF value is exemplified as the first characteristic value and the third characteristic value. The first characteristic value and the third characteristic value are not limited to the TF value as long as the values indicate a frequency of appearance of each word.

For example, appearance counts of all words in a document need not be used as the denominator, but appearance counts of all words that are filtered based on a predetermined rule may be used as the denominator.

The frequency of appearance of each word may be calculated by using a value obtained by weighting its appearance count. Alternatively, the frequency of appearance of each word may be calculated by using a logarithm of its appearance count or a converted value obtained based on a function prepared in advance. Those values are also characteristic values correlated to the frequency of appearance.

(2) In the exemplary embodiments described above, the IDF value is exemplified as the second characteristic value and the fourth characteristic value. The second characteristic value and the fourth characteristic value are not limited to the IDF value as long as the values indicate a reciprocal of the ratio of the number of documents including each word.

For example, the ratio need not be calculated by directly using the total number of documents in a higher-level folder including the parent folder of the target document and the number of documents including each word, but may be calculated by using the number of documents weighted based on a distance from the target document.

As examples of the weight based on the distance from the target document, “1” may be given to a document belonging to the parent folder, “0.5” may be given to a document belonging to a parent folder of the parent folder, and “0.25” may be given to a document belonging to a folder at an even higher level or a sibling folder of the parent folder. Those weights are examples.

The logarithmic transformation is used for calculating the IDF value, but a value calculated without using the logarithmic transformation may be used instead.

For example, the ratio may be calculated by using a logarithm of the number of documents or a converted value obtained based on a function prepared in advance. Those values are also characteristic values correlated to the reciprocal of the ratio of the number of documents including each word.

(3) In the exemplary embodiments described above, all the words in the documents managed by the document management system 30 are management targets. Candidates for the management-target words may be limited depending on a purpose of attribute assignment. For example, information related to an author of a document and his/her organization may be excluded from the management-target words.

(4) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a processor configured to:
extract first characteristic values indicating frequencies of appearance of words in a target document to be processed among a plurality of documents managed based on a hierarchical relationship;
extract second characteristic values of the words that are correlated to reciprocals of ratios of the number of documents including the words to a total number of documents in a group of documents in a first group including the target document; and
assign words selected from among the words based on the first characteristic values and the second characteristic values to the target document as first attributes.

2. The information processing system according to claim 1, wherein the processor is configured to extract the second characteristic values for a total number of documents in a second group incorporating the first group.

3. The information processing system according to claim 2, wherein the processor is configured to, in response to a change of contents of the target document, extract the first characteristic values and the second characteristic values based on the changed contents.

4. The information processing system according to claim 2, wherein the processor is configured to, in response to a change of a hierarchical position of the target document, extract the first characteristic values and the second characteristic values based on the changed hierarchical position.

5. The information processing system according to claim 1, wherein the processor is configured to manage candidates for the words to be assigned as the first attributes on a hierarchical group basis.

6. The information processing system according to claim 5, wherein the processor is configured to limit the candidates depending on a purpose of assignment of the first attributes.

7. The information processing system according to claim 1, wherein the processor is further configured to:
extract third characteristic values correlated to frequencies of appearance of words in the group of documents in the first group;
extract fourth characteristic values of the words that are correlated to reciprocals of ratios of the number of documents including the words to a total number of documents in a group of documents in a second group incorporating the first group; and
assign words selected from among the words based on the third characteristic values and the fourth characteristic values to the target document in the first group as second attributes.

8. The information processing system according to claim 7, wherein the second attributes are distinguishable from the first attributes.

9. The information processing system according to claim 7, wherein the second attributes are words that do not appear in the target document.

10. The information processing system according to claim 7, wherein the processor is configured to, in response to detection of a change of the second attributes, reflect details of the change in the second attributes assigned to the target document.

11. The information processing system according to claim 7, wherein the words assigned as the second attributes do not overlap the words assigned as the first attributes.

12. The information processing system according to claim 7, wherein the processor is configured to add a part of the second attributes to the first attributes if the part of the second attributes is not included in the first attributes but is included in the target document.

13. The information processing system according to claim 7, wherein the processor is configured to, in response to copying or movement of the target document to a different group, inquire of a user whether to transfer the second attributes.

14. A non-transitory computer readable medium storing a program causing a computer that processes a plurality of documents managed based on a hierarchical relationship to execute a process comprising:
extracting first characteristic values indicating frequencies of appearance of words in a target document to be processed among the plurality of documents;
extracting second characteristic values of the words that are correlated to reciprocals of ratios of the number of documents including the words to a total number of documents in a group of documents in a first group including the target document; and
assigning words selected from among the words based on the first characteristic values and the second characteristic values to the target document as first attributes.

15. An information processing system comprising:
means for extracting first characteristic values indicating frequencies of appearance of words in a target document to be processed among a plurality of documents managed based on a hierarchical relationship;
means for extracting second characteristic values of the words that are correlated to reciprocals of ratios of the number of documents including the words to a total number of documents in a group of documents in a first group including the target document; and
means for assigning words selected from among the words based on the first characteristic values and the second characteristic values to the target document as first attributes.
